(19) United States
(12) Patent Application Publication
(10) Pub. No.: US 2025/0203431 A1
(43) Pub. Date: Jun. 19, 2025

(54) COMMUNICATION DEVICES AND METHODS

(71) Applicant: Sony Group Corporation, Tokyo (JP)

(72) Inventors: Daniel VERENZUELA, Stuttgart (DE); Thomas HANDTE, Stuttgart (DE)

(73) Assignee: Sony Group Corporation, Tokyo (JP)

(21) Appl. No.: 18/847,806

(22) PCT Filed: Mar. 16, 2023
(86) PCT No.: PCT/EP2023/056785

§ 371 Date: Sep. 17, 2024

(30) Foreign Application Priority Data
Apr. 1, 2022 (EP) 22166262.0

(51) Int. Cl. H04W 24/10; H04W 72/542; H04W 76/14

(52) U.S. Cl. CPC H04W 24/10; H04W 72/542; H04W 76/14

(57) ABSTRACT

A first communication device that is configured to operate as access point (AP) and to communicate with a second communication device that is configured to operate as station (STA) comprises circuitry configured to: transmit trial information to the second communication device and at least two third communication devices, the trial information requesting the second communication device and at least two third communication devices to perform link measurement and transmit link measurement information; perform link measurement and/or receive link measurement information from the second communication device and/or one or more third communication devices; and schedule, under consideration of the measured link and/or the received link measurement information, one or more overlay communication phases in which two third communication devices communicate with each other simultaneously with the communication between the first and second communication devices.

### BACKGROUND

### Field of the Disclosure

The present disclosure relates to communication devices and corresponding communication methods for overlay peer-to-peer (P2P) communication, in particular in a wireless network.

### Description of Related Art

P2P communication refers to communication (e.g. an exchange of frames or data units) directly between two communication devices (in particular stations (STAs)) of the same basic service set (BSS) without sending frames through the access point (AP). The concept of overlay P2P communication refers to simultaneous communication, in the same, overlapping or adjacent frequency channel, among at least two pairs of communication devices: a) two P2P communication devices (e.g. two P2P STAs, also denoted as third communication devices herein), also denoted herein as P2P link, and b) two other communication devices (e.g. an AP (also denoted as first communication device herein) and a non-AP STA (also denoted as second communication device herein)), also denoted herein as AP link. The content of the data exchanged within each pair is independent of the other pair. The P2P link and the AP link may however interfere with each other.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly nor impliedly admitted as prior art against the present disclosure.

### SUMMARY

It is an object to provide communication devices and methods for use in overlay P2P communication that enable the communication between the AP and a non-AP STA to be performed simultaneously with the communication between two P2P STAs avoiding or at least reducing potential interference between the P2P link and the AP link. It is a further object to provide a corresponding method as well as a corresponding computer program and a non-transitory computer-readable recording medium that stores therein a computer program product for implementing said method.

According to an aspect there is provided a first communication device configured to operate as access point (AP) and to communicate with a second communication device that is configured to operate as station (STA), the first communication device comprising circuitry configured to:
transmit trial information to the second communication device and at least two third communication devices, the trial information requesting the second communication device and at least two third communication devices to perform link measurement and transmit link measurement information,
perform link measurement and/or receive link measurement information from the second communication device and/or one or more third communication devices, and
schedule, under consideration of the measured link and/or the received link measurement information, one or more overlay communication phases in which two third communication devices communicate with each other simultaneously with the communication between the first and second communication devices.

According to a further aspect there is provided a third communication device configured to communicate with another third communication device, the third communication device comprising circuitry configured to:
receive trial information from a first communication device that is configured to operate as access point (AP) and to communicate with a second communication device that is configured to operate as station (STA), the trial information requesting the second communication device, the third communication device and at least another third communication device to perform link measurement and transmit link measurement information, and
participate in one or more overlay communication phases scheduled by the first communication device under consideration of the measured link and/or link measurement information, wherein the third communication device and another third communication device communicate with each other simultaneously with the communication between the first and second communication devices.

According to still further aspects corresponding methods, a computer program comprising program means for causing a computer to carry out the steps of the method disclosed herein, when said computer program is carried out on a computer, as well as a non-transitory computer-readable recording medium that stores therein a computer program product, which, when executed by a processor, causes the method disclosed herein to be performed are provided.

Embodiments are defined in the dependent claims. It shall be understood that the disclosed methods, the disclosed computer program and the disclosed computer-readable recording medium have similar and/or identical further embodiments as the claimed devices and as defined in the dependent claims and/or disclosed herein.

One of the aspects of the disclosure is to introduce an overlay P2P trial phase before the actual overlay P2P communication phase. The overlay P2P trial phase is used to evaluate the interference levels within overlay P2P transmissions and schedule the subsequent overlay P2P communication, in particular to define channel access and/or transmission rules to mitigate the interference effects and support a P2P link overlay with an AP link.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1 shows a diagram of TXOP sharing to support P2P communications according to IEEE 802.11be.

FIG. 2 shows diagrams illustrating the interference scenarios in overlay P2P communications within WLAN.

FIG. 3 shows a diagram illustrating the steps for overlay P2P communication operation.

FIG. 4 shows a diagram of an implementation of P2P trial and communication phases to enable overlay P2P communications in WLAN.

FIG. 5 shows diagrams of several different implementations of interference measurement and reporting.

FIG. 6 shows the SINR calculations for the AP link and P2P links overlaying in the UL and DL directions respectively.

FIG. 7 show a diagram of an embodiment that supports P2P communications overlay UL traffic only.

FIG. 8 show a diagram of an embodiment that supports P2P communications overlay DL traffic only.

FIG. 9 shows a diagram illustrating how a continuous overlay P2P operation can be supported with the aid of the P2P feedback status phase.

FIG. 10 shows a diagram of an example of the overlay P2P status feedback phase operation.

### DETAILED DESCRIPTION OF THE EMBODIMENTS

The rise of applications like virtual reality (VR), augmented reality (AR), remote surgery and smart manufacturing imposes strict latency and throughput requirements on wireless networks. Overlay peer-to-peer (P2P) communications can reduce latency and increase spectral efficiency via three main gains:
i. Direct link gain: The frames exchanged between P2P STAs do not need to go through the AP, which can reduce latency since the channel only needs to be accessed once as data goes directly from the source to the destination device.
ii. Spatial reuse gain: By having a P2P link overlay an AP link (both links operate simultaneously), the spectral efficiency can be increased, leading to larger overall throughput.
iii. Proximity gain: P2P links are established when the P2P STAs are in close proximity of each other. This results in better channel conditions that can support high data rates or power save operation with reduced transmit power.

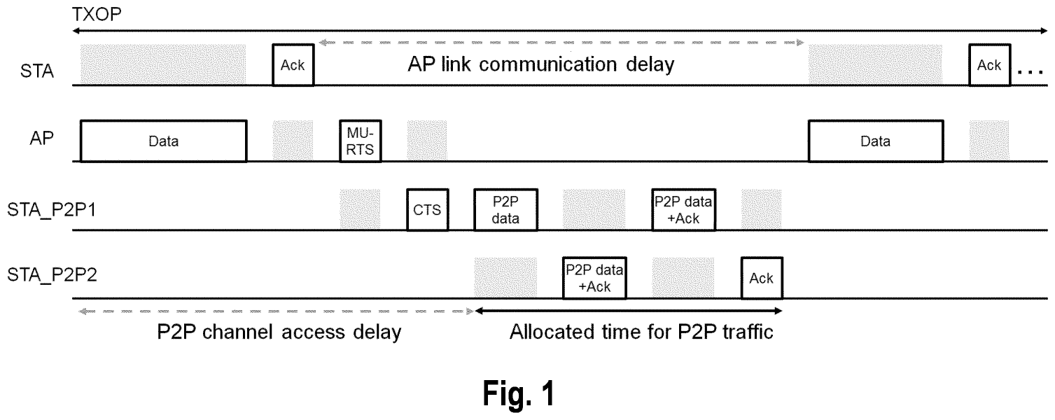

In the WLAN IEEE 802.11 standard, tunneled direct-link setup (TDLS) describes mechanisms to support P2P device discovery, link setup and channel switch operations. In the standard amendment IEEE 802.1 lax a quiet time period can be used by the AP to reduce interference. The AP reduces contention among STAs and provides a time window during which P2P STAs have preferred channel access for their P2P links. In the ongoing standard amendment IEEE 802.11 be, transmit opportunity (TXOP) sharing is introduced as a mechanism where the AP can allocate a time window within its TXOP and share it with another STA, including P2P STAs as shown in FIG. 1.

In the standardized solutions to support P2P traffic, the P2P link is always defined in a separate time window and/or frequency channel (e.g., via TDLS channel switch procedure) from the AP link, in order to avoid interference. However, this can lead to underutilization of the wireless medium and undesired delays in both P2P links (between STA_P2P1 and STA_P2P2) and AP links (between AP and STA) as shown in FIG. 1.

Since the P2P STAs are often located in close proximity of each other, they require less transmission power to communicate. Thus, it is possible for a P2P link and AP links to operate simultaneously (achieving their performance requirements, e.g., throughput and latency) in the same or adjacent frequency channels, as long as the interference levels among links are well managed.

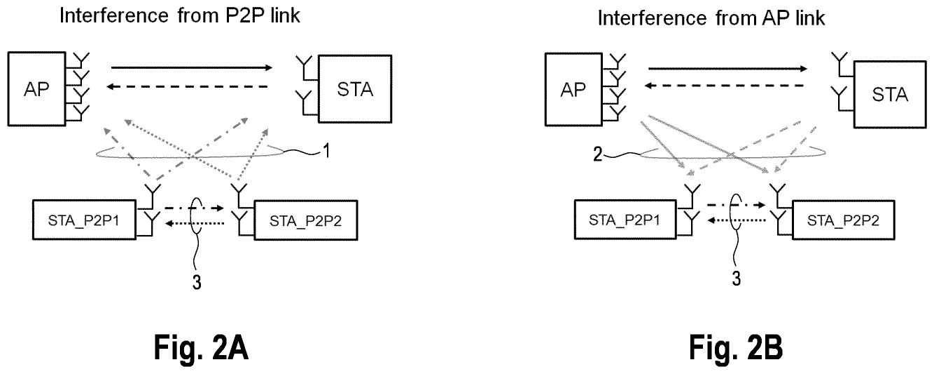

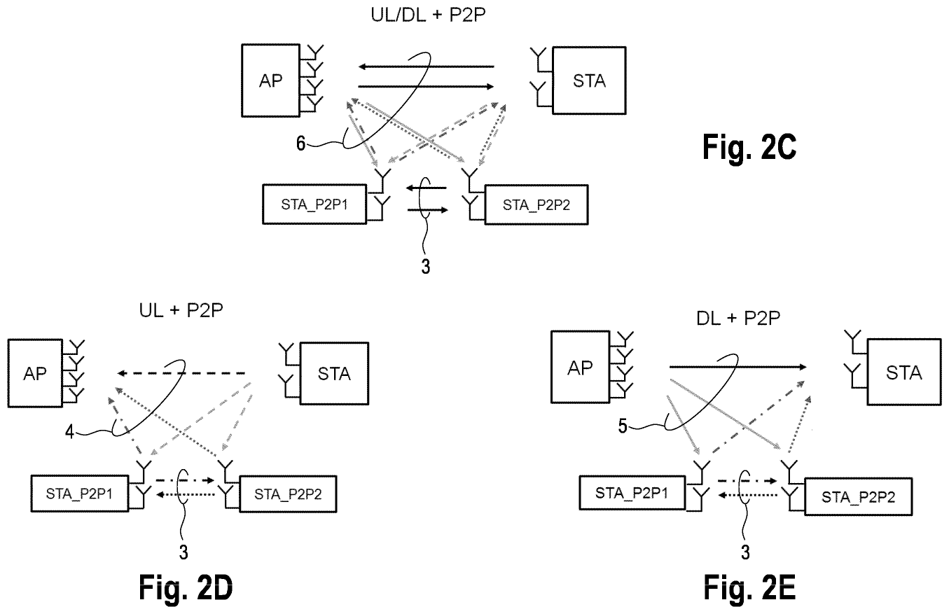

FIG. 2 shows diagrams illustrating the interference scenarios in overlay P2P communications within WLAN. There are two main sources of interference, one from the P2P link 3 towards the AP link (FIG. 2A) and another one from the AP link towards the P2P link 3 (FIG. 2B), in which the interfering links 1 and 2 are indicated. The exact interference level depends on which devices are transmitting and receiving within each P2P and AP link. Transmission and reception in P2P link and in AP to STA link are not synchronized. Therefore, the observed interference is time varying. Thus, to mitigate the interference it is necessary to estimate the interfering links shown in FIGS. 2A and 2B. Depending on this estimation, three main transmission configurations for overlay P2P communications can be adopted as shown in FIGS. 2C, 2D and 2E. The P2P link 3 can operate simultaneously with the uplink 4 (UL; shown in FIG. 2D), downlink 5 (DL; shown in FIG. 2E), or both directions 6 (shown in FIG. 2C) of the AP link. To support overlay P2P communications in WLAN, two mechanisms may be used: 1) Interference estimation phase to evaluate the interfering links, and 2) interference managed communication phase where rules for configuration of transmission parameters, channel access, and time/frequency alignment of links are defined. In the following, solutions to implement these mechanisms in WLAN according to the present disclosure will be described.

Before describing the proposed solutions in detail, the basic system model assumptions shall be mentioned. One basic service set (BSS) is considered containing one AP (herein also denoted as first communication device) and several non-AP STAs. The STAs (herein also denoted as second communication devices) may communicate with the AP to form a link, here denoted as an AP link, or among each other (those STAs herein also denoted as third communication devices) to form P2P links. A P2P discovery procedure is assumed to have taken place such that P2P STAs are aware of each other, the AP knows the identity of all STAs that may have P2P traffic and the AP is aware of buffer status of a STA's P2P traffic.

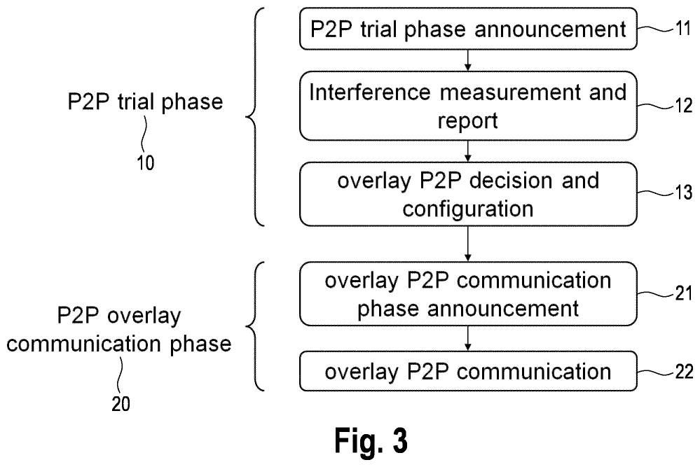

The disclosed solution may be developed in two phases as shown in FIG. 3, a P2P trial phase 10 and an overlay P2P communication phase 20. In the P2P trial phase 10, the P2P interference level is evaluated to decide if overlay P2P communication is possible, and if so, the minimum requirements for the AP link and P2P link configurations are determined to manage the interference. The P2P trial phase 10 may be done in three steps: a P2P trial announcement step 11, an interference measurement and report step 12 and an overlay P2P decision and configuration step 13.

In the P2P trial announcement step 11 an indication is transmitted by the AP to indicate the start of the P2P trial phase. The indication contains information regarding the interference measurement and reporting procedures and allows time alignment of interference measurement and report frames. Further, it enables all STAs to measure channel conditions between themselves and the AP. This can also be done in a separate PHY protocol data unit (PPDU), denoted as link measurement PPDU.

The interference measurement and report step 12 includes a transmission of link measurement PPDU from the devices that cause interference. The transmission configuration should enable a measurement of the maximum interference that the transmitting device would cause during the overlay P2P communication phase (e.g., maximum number of spatial streams and transmission power). All devices involved in the overlay P2P communication that are not transmitting, shall measure the level of interference caused by devices transmitting the link measurement PPDU. The link measurement report allows devices to report the measured interference to the AP attached to the transmission of a link measurement PPDU or in a separate link measurement report PPDU requested by the AP. The report request can be specified in the P2P trial announcement or in a separate frame.

In the overlay P2P decision and configuration step 13 (at the AP) information on the interfering links is collected and a signal-to-interference plus noise (SINR) metric is computed to evaluate the impact of interference on a potential overlay P2P communication. It is decided whether to schedule the overlay P2P communication or not if the SINR of the AP link and P2P link can be maintained above determined thresholds. If overlay P2P communication is scheduled, the limits for the transmitter configurations of the involved STAs are determined to support the SINR targets.

In the overlay P2P communication phase 20 (if scheduled by the P2P trial phase), the AP and P2P links are configured and scheduled in time and/or frequency. The overlay P2P communication phase may be implemented in two steps: a P2P communication phase announcement step 21 and an overlay P2P communication step 22.

In the P2P communication phase announcement step 21 the AP sends an indication to all STAs involved in the upcoming overlay P2P communication phase to indicate the configuration of the upcoming overlay P2P communication including one or more of direction of overlay links (i.e., UL+P2P, DL+P2P, UL/DL+P2P), transmission power, number of spatial streams and/or beamforming operation, bandwidth and/or subset of subcarriers or resource units (RU), PPDU size, modulation and coding scheme (MCS), a time window during which the AP link and the P2P link can operate simultaneously with the specified configuration, and frequency (sub-)channels where the AP link and P2P link can operate. These can be overlapped or adjacent.

In the overlay P2P communication step 22 the AP and the STA exchange frames via the AP link while, simultaneously, the P2P STAs exchange frames via the P2P link, in the same, adjacent or partially overlapping frequencies by respecting settings imposed by AP. Further mechanisms may be implemented to align the P2P link transmissions in time and/or frequency, depending on the direction of overlay links (i.e., UL+P2P, DL+P2P, UL/DL+P2P).

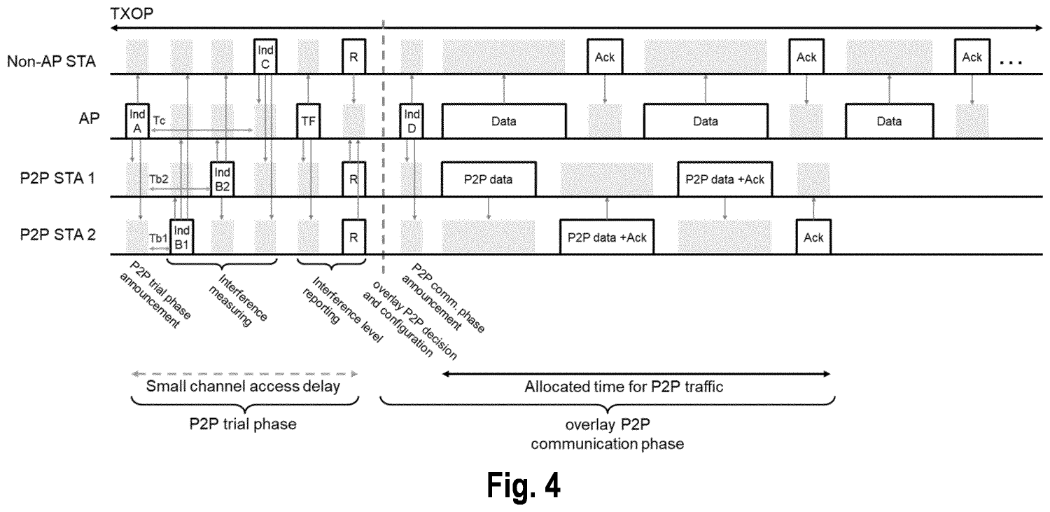

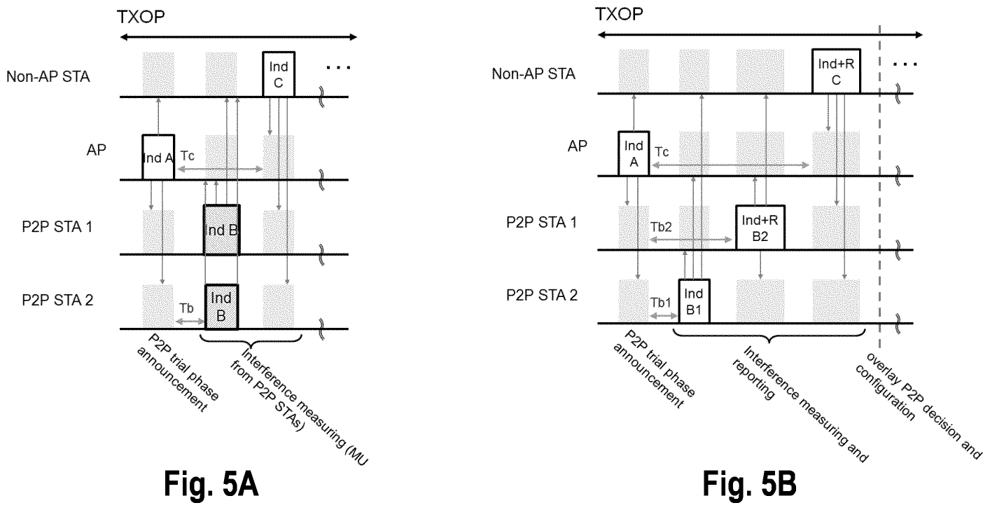

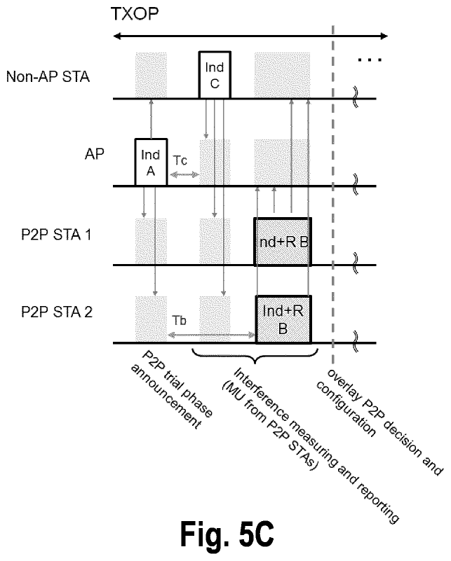

A basic implementing the P2P trial and communication phases is depicted in FIG. 4. The AP initiates the P2P trial phase by sending a P2P trial announcement “ind A” (herein also called “trial information”) that can be implemented as trigger frame (TF) variant where the responding STAs are requested to send a link measurement PPDU at specific times after the TF was sent. This indication includes one or more of the following:
Order in which each STA shall send a link measurement PPDU (herein also called “link measurement data unit”), illustrated by “ind B1”, “ind B2”, and “ind C” in FIG. 4.
Time parameters to align the transmissions of the link measurement PPDUs (i.e., Tb1, Tb2, and Tc as shown in FIG. 4).
Configuration of the link measurement PPDU. As an optional feature, the AP may want to predefine some initial limits for configuration of the link measurement PPDUs. The main reasons for configuring the link measurement PPDUs can be to limit the initial transmissions to avoid repeating several P2P trial phases or to pre-allocate some priority between links (e.g., P2P link has higher priority traffic and therefore can transmit with a higher maximum power or number of SS than the AP link, or vice versa).
The reporting mechanism may:
   Indicate if the link measurements will be reported in separated frames after the link measurement PPDUs, and the order in which the STAs will do so.
   Indicate if the link measurements will be collected by the AP via TF (as shown in FIG. 4, herein also called “report trigger”), in which case the STAs will wait for a TF after the link measurements have finished.
   Indicate if link measurements will be included to link measurement PPDUs (as shown in FIG. 5)
Reporting metric: The channel quality indication (CQI) or compressed beamforming feedback reports can be used as basis for the link measurement report (illustrated by “R”; herein also called “link measurement information”) to obtain average signal-to-noise (SNR) levels and SNR deviations on specific RUs or subcarriers and/or channel state information (CSI) on specific sub-channel, RUs, or subcarrier subsets.

The configuration of the link measurement PPDU may include one or more of the following:
Transmission power: Two options can be applied:
   STAs transmit at the maximum power levels needed to establish successful links with their peer devices, and the AP estimates a maximum received interference level.
   STAs transmit at a fixed power (set by the AP) and include in measurement reports their data rate requirements. The AP in turn estimates the pathloss towards the STAs, and based on their rate requirements it also estimates the resulting interference. This also requires that the AP has knowledge of the P2P direct link (i.e., pathloss or channel measurements) which can be obtained as part of the link measurement PPDU sent by P2P STAs or as fixed value that upper bounds the largest possible link budget between P2P STAs given the interference environment.
   Number of spatial streams (SS):
   Maximum number of SS that the STAs are allowed to use during the overlay P2P communication phase
   The AP may limit the number of SS that STAs use based its own number of antennas, to be able to distinguish as many spatial directions as possible, coming from STAs transmissions.
Bandwidth, frequency sub-band, RU and or subcarrier subset. The AP may assign different frequency resources to the AP link and P2P link from the start of the P2P trial phase to balance high spectrum utilization and interference management. If the whole bandwidth is used for overlayed P2P communication there is high spectrum utilization and high interference, whereas, if half-of the bandwidth is used for the AP-link and the other half for the P2P link, there is less interference while having lower spectrum utilization.

The estimation of interference, at receiving STAs, can be done by decoding the PHY preamble of the link measurement PPDU and measuring the received power level in the short training field (STF) and long training field (LTF). However, it may happen that the non-AP STA that will participate in the AP link is well separated from the P2P STAs and, although they may interfere with each other, the non-AP STA and P2P STAs transmissions may not be decodable by each other. In this case, they can only collect an average interference level by measuring the received power levels during the times where the link measurement PPDU are sent. To make sure the STAs are estimating the interference at the correct times one of the following solutions can be implemented: i) The AP may indicate via “ind A” the order and time (i.e., Tb1, Tb2, and Tc) during which each STA must transmit a link measurement PPDU (as shown in FIG. 4). ii) The AP may send a TF before each measurement packet that indicates which device shall send a link measurement PDU next. This option eliminates the need of time alignment parameters, but it also introduces more signaling overhead.

After the P2P trial phase 10, the AP may send an overlay P2P communication phase announcement “ind D” (herein also called “overlay communication indication”) to indicate one or more of the following:
Time window (herein also called “time information”) during which the overlay P2P communication will take place, as a time duration counted from a determined interframe space (IFS) directly after “ind D”.
Transmission configuration (herein also called “configuration information”) that each STAs can use (non-AP STA and P2P STAs). These can be absolute values or relative values to adjust the configuration used in the P2P trial phase, of one or more of transmission power, number of SS, bandwidth, beamforming weights, frequency (sub-) band, RU size and location, or subcarrier subset.

In the following, further aspects of the P2P trial phase will be described. In FIG. 5, several different implementations of interference measurement and reporting are presented. FIG. 5A shows a diagram illustrating multi-user (MU) link measurement, in particular a situation where the link measurement PPDU can be transmitted in different SS via MU-MIMO. To support this operation, the “ind A” announces the rows of the training matrix (known as P_HE_LTF matrix in IEEE 802.11ax) that each P2P STA shall use in “ind B”. These rows shall be different, since they correspond to orthogonal sequences that can allow the AP (and possibly the non-AP STA) to separate interference level estimation from each P2P STAs. The number of rows assigned to each P2P STA corresponds to the number of SS, wherein each of them is used to send “ind B”.

In the overlay P2P communication phase, the spatial mapping operation used by each P2P STA shall be substantially the same as the one used to transmit “ind B”, which entails the following aspects: The number of SS used by each P2P STA shall be lower than or equal to the number of SS used to transmit “ind B”; the spatial mapping matrix (e.g., beamforming matrix) shall be preserved; and the mapping of each SS and each row (or column) of the spatial mapping matrix shall be preserved.

In addition, since “ind B” is a MU-MIMO transmission, the transmission power of P2P STAs is set to achieve a target UL RSSI value at the AP. Thus, to enable accurate interference level estimation, the “ind B” may contain the exact power used by each P2P STA, which would enable the AP to estimate the channel towards the P2P STAs. Based on these channel estimates the AP can then estimate the P2P interference when the P2P STAs utilize other power levels, indicated in the measurement reports, that would be used in the overlay P2P communication phase. In case the non-AP STA cannot separate the SS from different P2P STAs, it can still obtain an estimate of the aggregated interference caused by P2P links.

FIG. 5B shows a diagram illustrating combined measurement and reporting, in particular the case where the interference measurement report of link measurement PPDUs that have already been sent can be attached to subsequent link measurement PPDUs and where the AP link reporting is made last. This has the benefit of reducing the number PPDUs needed to be sent in the P2P trial phase. Since the STAs cannot report on link measurement PPDUs that have not been transmitted, the first STA in the P2P trial phase does not have anything to report and the last STA can report interference levels from all other STAs. In case the interference levels are reciprocal, i.e., the interference from P2P STA 1 measured at the non-AP STA is the same as the one from the non-AP STA measured at the P2P STA 1, this procedure can provide all interference level information to the AP in an efficient manner. However, if the interference measurements are non-reciprocal, this embodiment adds priority to the last STA transmitting in the P2P trial phase given that its interference measurement report will be complete. The missing non-reciprocal links can be estimated by the AP by using information about the transmission configuration of the STAs (e.g., beamforming matrix and number of SS)

FIG. 5C shows a diagram of a combination of the implementations shown in FIGS. 5A and 5B where the P2P STAs transmit a MU link measurement PPDU that contains a report of the interference measured from the non-AP STA transmission of “ind C” and where the P2P link reporting is made last.

After the P2P trial phase, the AP evaluates all SINR expressions based on the interference measurements and reports it has received and decides to schedule an overlayed P2P communication by one or more of the following evaluations:
The SINR of AP and P2P links are above predetermined thresholds. The solution of an optimization problem is based on SINR values and/or interference levels to optimize a combined performance metric (e.g., maximum total throughput, maximum worst throughput, or minimum interference).
A predetermined minimum data rates can be supported for the AP link.
A predetermined minimum data rate can be supported by the P2P links in both directions (e.g., from P2P_STA_1 to P2P_STA_2 and vice versa).
Interference levels caused by the AP link and/or P2P links are below predefined values.

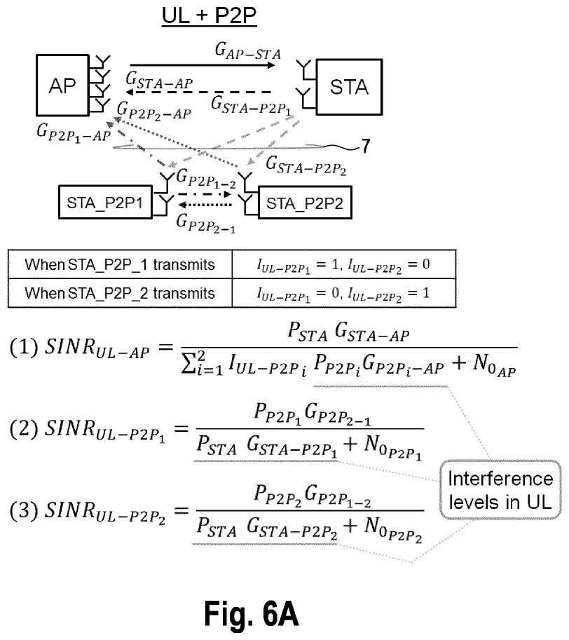

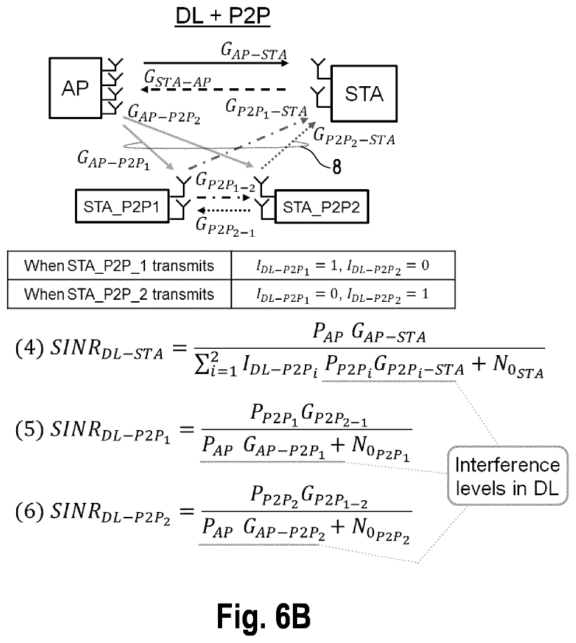

FIG. 6 shows the SINR calculations for the AP link and P2P links overlaying in the UL (FIG. 6A) and DL (FIG. 6B) directions respectively, where interfering links are indicated by reference signs 7 and 8, respectively. The SINR_{UL-AP} and SINR_{DL-STA} correspond to the SINR at the AP link receivers, i.e., AP and non-AP STA in UL and DL, respectively. The SINR_{UL-P2P}, and SINR_{DL-P2P}_{ᵢ} correspond to the SINR at the P2P_STA_i acting as receiver during UL and DL transmissions, respectively. The transmission powers and channel gains (including beamforming effects and MIMO equalization) are depicted by P_{X} and G_{X_Y}, respectively, where “X” refers to the transmitter and “Y” the receiver.

For the basic example shown in FIG. 4, the following table illustrates the received power calculations, matched to the SINR equations in FIG. 6, for each indication and how it is sent to the AP:

TABLE 1
Interference and link gain information collection for SINR calculations

| Indication | Receiver | Received power calculation | Report to AP |
|---|---|---|---|
| Ind A | Non-AP STA | DL Link gain (numerator eq. (4)) | Via separate frame |
| | P2P STAs | DL AP interference (denominator eq. (5-6)) | (R, in FIG. 4) |
| Ind B1 | AP | P2P UL interference (denominator eq. (1)) | Already at the AP |
| | Non-AP STA | P2P DL interference (denominator eq. (4)) | Via separate frame |
| | P2P STA 1 | P2P link gain (numerator eq. (2, 5)) | (R, in FIG. 4) |
| Ind B2 | AP | P2P UL interference (denominator eq. (1)) | Already at the AP |
| | Non-AP STA | P2P DL interference (denominator eq. (4)) | Via separate frame |
| | P2P STA 2 | P2P link gain (numerator eq. (3, 6)) | (R, in FIG. 4) |
| Ind C | AP | UL link gain (numerator eq. (1)) | Already at the AP |
| | P2P STAs | UL non-AP STA interference (denominator | Via separate frame |
| | | eq. (2-3)) | (R, in FIG. 4) |

The interference measurement and reporting methods provide the AP with full or partial information for the SINR calculations. Full information means more accurate SINR calculations and better control of the overlay P2P performance at the expense of more signaling overhead.

The interference measurement and reporting shown in FIG. 4 and detailed in Table 1 is the most complete, wherein all interference level and link gains can be individually measured and reported. Thus, it is robust even in cases when links are not reciprocal. For the cases in FIG. 5, the differences with the main implementation and additional requirements needed to implement them will be described (all equation references correspond to FIG. 6).

“Ind B” may be sent in a MU-MIMO transmission (as shown in FIG. 5A). The AP can receive and estimate the interference levels from each separate P2P STA (denominator of eq. (1)). The non-AP STA may not be able to separate the interference levels for each P2P STA but still it can get a combined interference level (i.e., I_{DL-P2P}_{₁}=1 and I_{DL-P2P}_{₂}=1 in eq. (4)) which results in a lower bound on the DL SINR. The link gain between P2P STAs cannot be obtained in this method since the P2P STAs transmit at the same time. Thus, the AP can use a predetermined value, which would enable a minimum rate. The P2P STAs can then use link adaptation mechanism (e.g., use lower MCS or number of SS) to adjust to their link conditions without increasing their transmission power.

Combined measurement and reporting (as shown in FIG. 5B) may be performed as follows. “Ind+R B2” may be included, i.e., P2P STA 1 can report the P2P direct link gain (numerator eq. (2, 5)) to the AP, based in the previously received “ind B1”, and the AP assumes reciprocal P2P link gains. “Ind+R C” may be included, i.e., non-AP STA can report on all P2P DL interference levels (denominator of eq. (4)) to the AP. The AP then assumes that the interfering links from P2P STAs to the non-AP STA are reciprocal (G_{STA-P2P}_{ᵢ}=G_{P2P}_{ᵢ}_{-STA}) and therefore it can obtain the UL non-AP STA interference received at P2P STAs (denominator of eq. (2-3)). The received power levels at P2P STA 2 cannot be reported to the AP, thus similarly to the previous case, the AP assumes that the link measure from “ind 1” is reciprocal to the one from the AP to P2P STA 2. This would enable the AP to know if its own transmissions would cause too much interference to P2P STA 2.

It shall be noted that links that are calculated based on reciprocal measurements are less accurate, and therefore an implicit priority is given to the devices scheduled to transmit a combined measurement and report frame towards the end of a P2P trial phase.

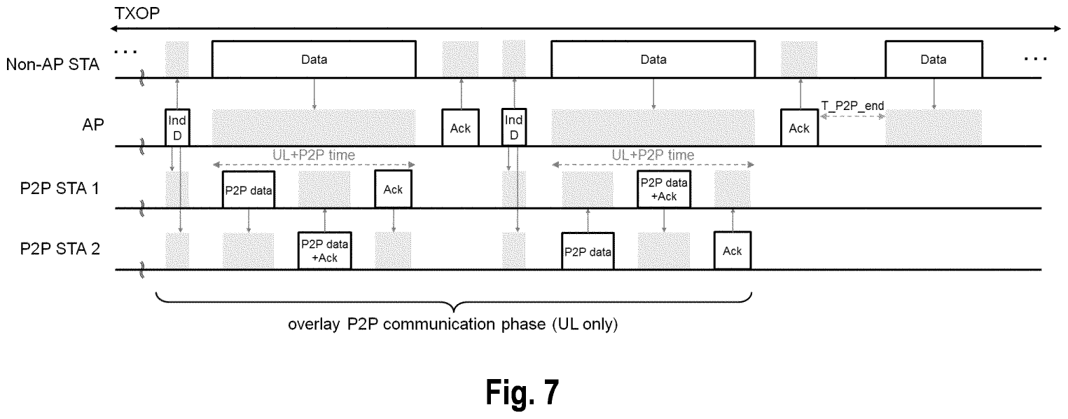

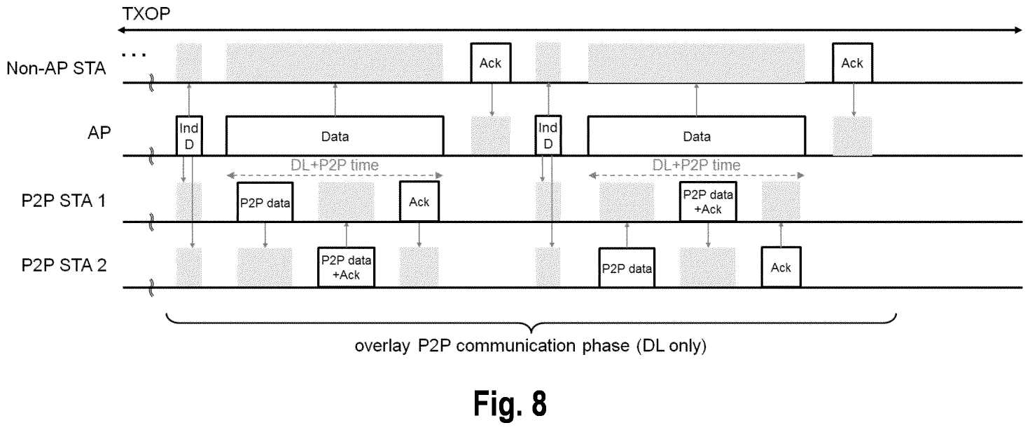

Further aspects on overlay P2P communication configuration relate to the direction of overlay AP links. Once the P2P trial phase concludes, the AP may find important differences between UL and DL SINR calculations resulting in a viable overlay P2P communication only in one direction of the AP link, either UL or DL. FIGS. 7 and 8 show diagrams illustrating the envisioned mechanism to support P2P communications overlay UL traffic only (FIG. 7) or DL traffic only (FIG. 8), respectively. To schedule the overlay P2P traffic, the AP sends the “ind D” before each AP link PPDU where the overlay P2P may take place.

The AP includes the overlay AP link direction (DL or UL) in the indication “ind D” and the duration of the upcoming PPDU. The AP configures the duration of the PPDU for the AP link which corresponds to the “UL+P2P time” or “DL+P2P time” as illustrated in FIGS. 7 and 8, respectively. The P2P STAs may then exchange frames via P2P links within this time.

In the UL case, the AP may not be the owner of the TXOP, which means that it is the non-AP STA that initiates all transmissions. To solve this issue, the AP may send “ind A” to indicate to the non-AP STA to stop sending UL traffic to allow for a P2P trial phase to take place. The non-AP STA may resume its UL transmission after receiving another indication as part of “ind D”. This indication may contain a specific transmission configuration to support AP link and P2P link SINR levels computed in the P2P trial phase. To resume regular uplink transmission, the non-AP STA can either 1) wait for a predetermined interframe space (IFS) shows as “T_P2P_end” in FIG. 7, where no indication from the AP is received, or 2) received within “ind D” a notification there will not be more overlay P2P traffic for the rest of the TXOP.

Next, the overlay P2P status feedback phase will be described. Due to the changes in the wireless medium and data traffic requirements, it may happen that the interference scenario changes within the overlay P2P communication phase. This means that several P2P trial and overlay P2P communication phases may be needed in the same or different TXOP.

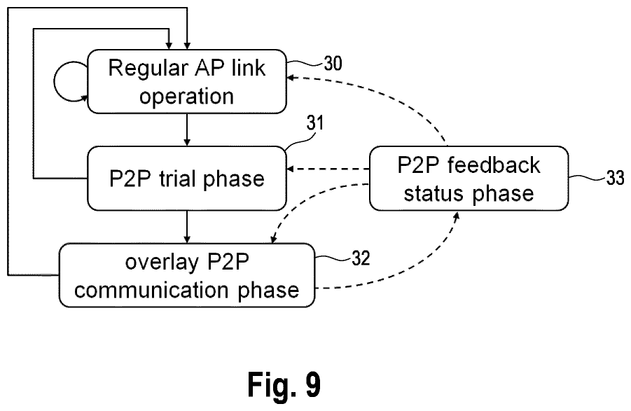

Thus, a P2P status feedback phase may be provided for the AP to evaluate the status of the overlay P2P communication and continuously schedule overlay P2P traffic when needed and if possible. FIG. 9 shows a diagram illustrating how a continuous overlay P2P operation can be supported with the aid of the P2P feedback status phase (illustrated by the dashed lines). As a starting point, the BSS is assumed to be operating with regular AP link operation 30. Then, P2P trial phase 31 and overlay communication phase 32 take place. During or after the overlay P2P communication phase 32, a P2P feedback status phase 33 can be implemented to enable the AP to collect information regarding the status of the overlay P2P communication, for example, packet error rate (PER), SINR or channel measurements of each P2P STA involved in the overlay P2P communication. Based on this information the AP can decide to perform one or more of the following steps.

P2P traffic may be cancelled and it may be returned to regular AP link operation in case the P2P link performs poorly and/or generates too much interference. Further, a new P2P trial phase 31 may be initiated in case the interference scenario has changed, and better performance can be obtained by collecting new link measurement reports. Since the AP already has some information about the interference scenario, a reduced P2P trial phase (herein this phase may also include the transmission of update trial information by the AP) can be implemented where only a selected subset of STAs performs link measurement PPDUs and/or reports. Still further, another overlay P2P communication may be initiated. In this case, if the AP receives indications that all links are working well, then it can schedule another overlay P2P communication phase 32.

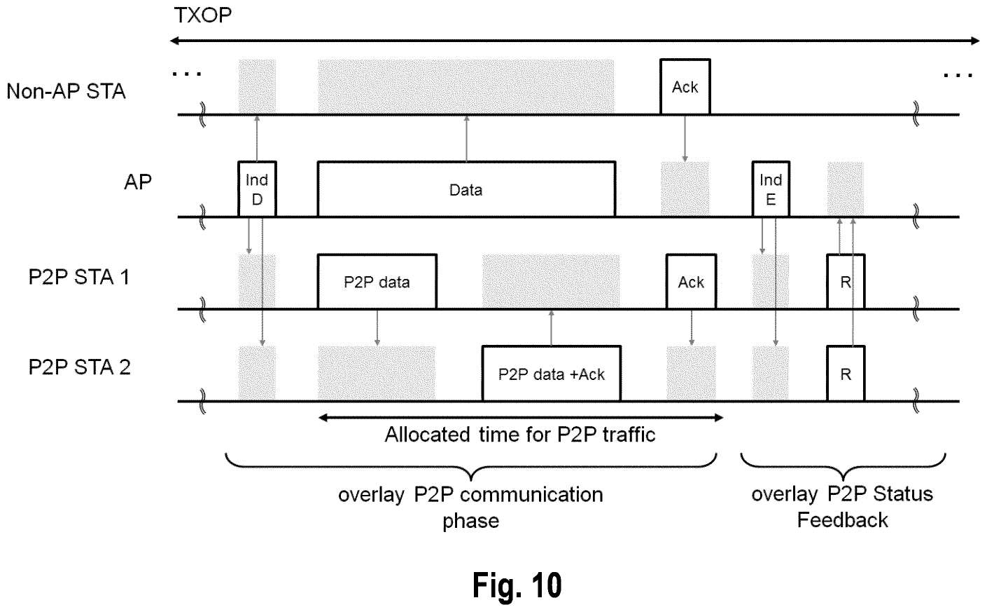

An example of the overlay P2P status feedback phase operation is shown in FIG. 10. According to this example, “ind E” is sent directly after the end of the overlay P2P communication phase to indicate to P2P STAs the start of a P2P status feedback phase. This can be implemented by a TF variant where P2P STAs reply with a report “R” of the performance of their previous frame exchange (herein also called “status information”). This report can be a simple message to indicate that all previous frame exchange was successful, or it can contain more detailed channel measurements and PER values in case errors in the communication above certain target (e.g., PER>10%) were experienced. After collecting this information one of the following operations can happen: Regular AP link operation can be performed, meaning that the AP does not send any P2P related indications and the AP link traffic resumes; a P2P trial phase may be carried out, where the AP would send an “ind A”; or an overlay P2P communication phase may be initiated, where the AP would send an “ind D”.

In summary, mechanisms are presented to support peer-to-peer (P2P) communications overlay with the communication between an access point (AP) and a non-AP station (STA) within a basic service set (BSS) in WLAN. Since P2P and AP links may interfere with each other, the proposed mechanisms define an overlay P2P interference trial phase followed by an overlay P2P communication phase in WLAN. The former is used to evaluate the interference levels within overlay P2P transmissions and the latter defines channel access and transmission rules to mitigate the interference effects and support a P2P link overlay with AP links.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

The elements of the disclosed devices, apparatus and systems may be implemented by corresponding hardware and/or software elements, for instance appropriate circuits or circuitry. A circuit is a structural assemblage of electronic components including conventional circuit elements, integrated circuits including application specific integrated circuits, standard integrated circuits, application specific standard products, and field programmable gate arrays. Further, a circuit includes central processing units, graphics processing units, and microprocessors which are programmed or configured according to software code. A circuit does not include pure software, although a circuit includes the above-described hardware executing software. A circuit or circuitry may be implemented by a single device or unit or multiple devices or units, or chipset(s), or processor(s).

It follows a list of further embodiments of the disclosed subject matter:

1. First communication device configured to operate as access point (AP) and to communicate with a second communication device that is configured to operate as station (STA), the first communication device comprising circuitry configured to:
transmit trial information to the second communication device and at least two third communication devices, the trial information requesting the second communication device and at least two third communication devices to perform link measurement and transmit link measurement information,
perform link measurement and/or receive link measurement information from the second communication device and/or one or more third communication devices, and
schedule, under consideration of the measured link and/or the received link measurement information, one or more overlay communication phases in which two third communication devices communicate with each other simultaneously with the communication between the first and second communication devices.
   2. First communication device as defined in embodiment 1, wherein the circuitry is configured to:
receive link measurement data units transmitted by the second communication device and/or one or more third communication devices,
perform link measurement based on the received link measurement data units, and
receive link measurement information from the second communication device and/or one or more third communication devices, the link measurement information indicating the link measured by the second communication device and/or the one or more third communication devices based on the transmitted link measurement data units.
   3. First communication device as defined in any one of the preceding embodiments, wherein the circuitry is configured to transmit trial information that contains a link measurement data unit as part of a single data unit or as separate data units.
   4. First communication device as defined in any one of the preceding embodiments, wherein the circuitry is configured to transmit update trial information to the second communication device and/or third communication devices comprising a request requesting the second communication device and/or at least one third communication device to perform link measurement and/or to transmit a link measurement data unit and/or to transmit link measurement information to the first communication device.
   5. First communication device as defined in any one of the preceding embodiments, wherein the circuitry is configured to transmit an overlay communication indication to the second communication device and two third communication devices, the overlay communication indication indicating to the second communication device and two third communication devices that overlay communication has been scheduled for them.
   6. First communication device as defined in embodiment 5, wherein the circuitry is configured to include in the overlay communication indication one or more of:
configuration information for configuring at least the two third communication devices for the overlay communication, the configuration information including one or more of transmission power, number of spatial streams, bandwidth, beamforming weights, frequency sub-band, resource unit size and/or location, and subcarrier subset, and
time information indicating a time window for performing the overlay communication.
information that the overlay communication of the two third communication devices is scheduled simultaneously with only the uplink or downlink of the communication between the first and second communication device.
   7. First communication device as defined in any one of the preceding embodiments, wherein the circuitry is configured to communicate with the second communication device at least partly simultaneously with the overlay communication between the two third communication devices.
   8. First communication device as defined in any one of the preceding embodiments, wherein the circuitry is configured to communicate with the second communication device in a frequency bandwidth that at least partly overlaps with the bandwidth of the overlay communication between the two third communication devices.
   9. First communication device as defined in any one of the preceding embodiments, wherein the circuitry is configured to include in the trial information one or more of:
an indication to start a trial phase,
information regarding link measurement procedure, measurement reporting mechanism and/or reporting metric,
time information regarding timing when the second communication device and/or the one or more third communication devices shall perform link measurement and measurement reporting,
a request to measure channel conditions between the respective communication device and the first communication device,
the order in which the second communication device and the third communication devices transmit link measurement data units,
configuration of the link measurement data units, the configuration including one or more of transmission power, number of spatial streams, bandwidth, beamforming weights, frequency sub-band, resource unit(s) and subcarrier subset.
   10. First communication device as defined in any one of the preceding embodiments, wherein the circuitry is configured to schedule the overlay communication by determining signal-to-interference plus noise ratio (SINR) or signal-to-noise ratio (SNR) based on the measured link and the received link measurement information, and to decide if overlay communication is allowed or not based on the SINR or SNR.
   11. First communication device as defined in embodiment 10, wherein the circuitry is configured to
determine SINR or SNR values for uplink and/or downlink communication between the first and second communication devices and SINR or SNR values for each link involved in the overlay communication between the two third communication devices, and
decide if overlay communication is allowed based one or more of:
   the SINR of the uplink or downlink communication between first and second communication devices is above a predetermined threshold;
   the SINR for one or both of the links between the two third communication devices is above a predetermined threshold; and
   the solution to an optimization problem based on joint SINR or SNR values from uplink, downlink and/or overlay communication links between the two third communication devices.
      12. First communication device as defined in any one of the preceding embodiments, wherein the circuitry is configured to inform the second communication device to stop transmitting data units before or along with transmitting the trial information to allow for a trial phase in which link measurement is performed for subsequently scheduling the overlay communication phase and/or to inform the second communication device to resume transmitting data units after the trial phase.
      13. First communication device as defined in any one of the preceding embodiments, wherein the circuitry is configured to inform the second communication device to transmit data units in a non-overlay communication phase, in which only the communication between the first and second communication devices occurs, after an overlay communication phase.
      14. First communication device as defined in any one of the preceding embodiments, wherein the circuitry is configured to collect, during or after the overlay communication phase, status information regarding the status of the overlay communication and to decide, based on the collected status information, to return to a non-overlay communication phase, wherein only the communication between the first and second communication devices occurs, or to initiate a new trial phase or to initiate a new overlay communication phase.
      15. First communication device as defined in any one of the preceding embodiments, wherein the trial information comprises a trial announcement or a trigger that is transmitted directly to the second communication device and/or the third communication devices within the same basic service set or that is broadcasted within the basic service set.
      16. First communication device as defined in any one of the preceding embodiments, wherein the circuitry is configured to transmit, after receipt of the link measurement data units, a report trigger requesting the second communication device and/or one or more third communication devices to transmit the link measurement information.
      17. First communication device as defined in any one of the preceding embodiments, wherein the circuitry is configured to receive the link measurement information included in or attached to a link measurement data unit.
      18. First communication device as defined in any one of the preceding embodiments, wherein the circuitry is configured to determine, for configuring at least the two P2P communication devices for the overlay P2P communication, transmission parameters, preferably in time and/or frequency, for transmitting data units by the P2P communication devices during the overlay P2P communication based on the measured links and the received link measurement information
      19. First communication device as defined in any one of the preceding embodiments, wherein the transmission parameters include one or more of:
direction of overlay links,
transmission power,
number of spatial streams and/or beamforming operation,
bandwidth and/or subset of subcarriers or resource units,
size of data units,
modulation and coding scheme,
time window for simultaneous overlay P2P communication,
frequency channels used for the overlay P2P communication, in particular identical, adjacent or at least partially overlapping frequency channels.
   20. Third communication device configured to communicate with another third communication device, the third communication device comprising circuitry configured to:
receive trial information from a first communication device that is configured to operate as access point (AP) and to communicate with a second communication device that is configured to operate as station (STA), the trial information requesting the second communication device, the third communication device and at least another third communication device to perform link measurement and transmit link measurement information, and
participate in one or more overlay communication phases scheduled by the first communication device under consideration of the measured link and/or link measurement information, wherein the third communication device and another third communication device communicate with each other simultaneously with the communication between the first and second communication devices.
   21. Third communication device as defined in embodiment 20, wherein the circuitry is configured to:
transmit one or more link measurement data units to one or more of the first and second communication devices and another third communication device,
receive link measurement data units transmitted by the second communication device and at least another third communication device,
perform link measurement based on the received link measurement data units,
transmit link measurement information to the first communication device, the link measurement information indicating the measured link.
   22. Third communication device as defined in any one of embodiments 20 to 21, wherein the circuitry is configured to receive trial information that contains a link measurement data unit as part of a single data unit or as separate data units.
   23. Third communication device as defined in any one of embodiments 20 to 22, wherein the circuitry is configured to transmit the link measurement data unit using a transmission configuration that enables measurement of the maximum received power that may occur in the overlay communication phase.
   24. Third communication device as defined in any one of embodiments 20 to 23, wherein the circuitry is configured to transmit the link measurement information included in or attached to a link measurement data unit or as a separate link measurement report.
   25. Third communication device as defined in any one of embodiments 20 to 24, wherein the circuitry is configured to receive, after transmission of the link measurement data units, a report trigger requesting the third communication device to transmit the link measurement information.
   26. Third communication device as defined in any one of embodiments 20 to 25, wherein the circuitry is configured to perform link measurement by decoding the preamble of link measurement data units and measuring the received power level.
   27. Third communication device as defined in any one of embodiments 20 to 26, wherein the circuitry is configured to communicate with another third communication device using the same configuration that has been used for transmitting the link measurement data unit.
   28. Third communication device as defined in any one of embodiments 20 to 27, wherein the third communication device and/or the another third communication device are a member of the basic service set that is served by the first communication device.
   29. First communication method of a first communication device configured to operate as access point (AP) and to communicate with a second communication device that is configured to operate as station (STA), the first communication method comprising:
transmitting trial information to the second communication device and at least two third communication devices, the trial information requesting the second communication device and at least two third communication devices to perform link measurement and transmit link measurement information,
performing link measurement and/or receive link measurement information from the second communication device and/or one or more third communication devices, and
scheduling, under consideration of the measured link and/or the received link measurement information, one or more overlay communication phases in which two third communication devices communicate with each other simultaneously with the communication between the first and second communication devices.
   30. Third communication method of a third communication device configured to communicate with another third communication device, the third communication device comprising circuitry configured to:
receive trial information from a first communication device that is configured to operate as access point (AP) and to communicate with a second communication device that is configured to operate as station (STA), the trial information requesting the second communication device, the third communication device and at least another third communication device to perform link measurement and transmit link measurement information, and
participate in one or more overlay communication phases scheduled by the first communication device under consideration of the measured link and/or link measurement information, wherein the third communication device and another third communication device communicate with each other simultaneously with the communication between the first and second communication devices.
   31. A non-transitory computer-readable recording medium that stores therein a computer program product, which, when executed by a processor, causes the method according to embodiment 29 or 30 to be performed.
   32. A computer program comprising program code means for causing a computer to perform the steps of said method according to embodiment 29 or 30 when said computer pro-gram is carried out on a computer.

1. First communication device configured to operate as access point (AP) and to communicate with a second communication device that is configured to operate as station (STA), the first communication device comprising circuitry configured to:
transmit trial information to the second communication device and at least two third communication devices, the trial information requesting the second communication device and at least two third communication devices to perform link measurement and transmit link measurement information,
perform link measurement and/or receive link measurement information from the second communication device and/or one or more third communication devices, and
schedule, under consideration of the measured link and/or the received link measurement information, one or more overlay communication phases in which two third communication devices communicate with each other simultaneously with the communication between the first and second communication devices.

2. First communication device as claimed in claim 1,
wherein the circuitry is configured to:
receive link measurement data units transmitted by the second communication device and/or one or more third communication devices,
perform link measurement based on the received link measurement data units, and
receive link measurement information from the second communication device and/or one or more third communication devices, the link measurement information indicating the link measured by the second communication device and/or the one or more third communication devices based on the transmitted link measurement data units.

3. First communication device as claimed in claim 1,
wherein the circuitry is configured to transmit one or more of
trial information that contains a link measurement data unit as part of a single data unit or as separate data units, and—update trial information to the second communication device and/or third communication devices comprising a request requesting the second communication device and/or at least one third communication device to perform link measurement and/or to transmit a link measurement data unit and/or to transmit link measurement information to the first communication device.

4. First communication device as claimed in claim 1,
wherein the circuitry is configured to transmit an overlay communication indication to the second communication device and two third communication devices, the overlay communication indication indicating to the second communication device and two third communication devices that overlay communication has been scheduled for them and/or to include in the overlay communication indication one or more of:
configuration information for configuring at least the two third communication devices for the overlay communication, the configuration information including one or more of transmission power, number of spatial streams, bandwidth, beamforming weights, frequency sub-band, resource unit size and/or location, and subcarrier subset,
time information indicating a time window for performing the overlay communication, and
information that the overlay communication of the two third communication devices is scheduled simultaneously with only the uplink or downlink of the communication between the first and second communication device.

5. First communication device as claimed in claim 1,
wherein the circuitry is configured to communicate with the second communication device at least partly simultaneously with the overlay communication between the two third communication devices and/or in a frequency bandwidth that at least partly overlaps with the bandwidth of the overlay communication between the two third communication devices.

6. First communication device as claimed in claim 1,
wherein the circuitry is configured to include in the trial information one or more of:
an indication to start a trial phase,
information regarding link measurement procedure, measurement reporting mechanism and/or reporting metric,
time information regarding timing when the second communication device and/or the one or more third communication devices shall perform link measurement and measurement reporting,
a request to measure channel conditions between the respective communication device and the first communication device,
the order in which the second communication device and the third communication devices transmit link measurement data units,
configuration of the link measurement data units, the configuration including one or more of transmission power, number of spatial streams, bandwidth, beamforming weights, frequency sub-band, resource unit(s) and subcarrier subset.

7. First communication device as claimed in claim 1,
wherein the circuitry is configured to schedule the overlay communication by determining signal-to-interference plus noise ratio (SINR) or signal-to-noise ratio (SNR) based on the measured link and the received link measurement information, and to decide if overlay communication is allowed or not based on the SINR or SNR.

8. First communication device as claimed in claim 7,
wherein the circuitry is configured to
determine SINR or SNR values for uplink and/or downlink communication between the first and second communication devices and SINR or SNR values for each link involved in the overlay communication between the two third communication devices, and
decide if overlay communication is allowed based one or more of:
the SINR of the uplink or downlink communication between first and second communication devices is above a predetermined threshold;
the SINR for one or both of the links between the two third communication devices is above a predetermined threshold; and
the solution to an optimization problem based on joint SINR or SNR values from uplink, downlink and/or overlay communication links between the two third communication devices.

9. First communication device as claimed in claim 1,
wherein the circuitry is configured to inform the second communication device to stop transmitting data units before or along with transmitting the trial information to allow for a trial phase in which link measurement is performed for subsequently scheduling the overlay communication phase and/or to inform the second communication device to resume transmitting data units after the trial phase.

10. First communication device as claimed in claim 1,
wherein the circuitry is configured to inform the second communication device to transmit data units in a non-overlay communication phase, in which only the communication between the first and second communication devices occurs, after an overlay communication phase.

11. First communication device as claimed in claim 1,
wherein the circuitry is configured to collect, during or after the overlay communication phase, status information regarding the status of the overlay communication and to decide, based on the collected status information, to return to a non-overlay communication phase, wherein only the communication between the first and second communication devices occurs, or to initiate a new trial phase or to initiate a new overlay communication phase.

12. First communication device as claimed in claim 1,
wherein the trial information comprises a trial announcement or a trigger that is transmitted directly to the second communication device and/or the third communication devices within the same basic service set or that is broadcasted within the basic service set.

13. First communication device as claimed in claim 1,
wherein the circuitry is configured to transmit, after receipt of the link measurement data units, a report trigger requesting the second communication device and/or one or more third communication devices to transmit the link measurement information.

14. Third communication device configured to communicate with another third communication device, the third communication device comprising circuitry configured to:
receive trial information from a first communication device that is configured to operate as access point (AP) and to communicate with a second communication device that is configured to operate as station (STA), the trial information requesting the second communication device, the third communication device and at least another third communication device to perform link measurement and transmit link measurement information, and
participate in one or more overlay communication phases scheduled by the first communication device under consideration of the measured link and/or link measurement information, wherein the third communication device and another third communication device communicate with each other simultaneously with the communication between the first and second communication devices.

15. Third communication device as claimed in claim 14,
wherein the circuitry is configured to:
transmit one or more link measurement data units to one or more of the first and second communication devices and another third communication device,
receive link measurement data units transmitted by the second communication device and at least another third communication device,
perform link measurement based on the received link measurement data units,
transmit link measurement information to the first communication device, the link measurement information indicating the measured link.

16. Third communication device as claimed in claim 15,
wherein the circuitry is configured to transmit the link measurement data unit using a transmission configuration that enables measurement of the maximum received power that may occur in the overlay communication phase and/or to communicate with another third communication device using the same configuration that has been used for transmitting the link measurement data unit.

17. Third communication device as claimed in claim 14,
wherein the circuitry is configured to transmit the link measurement information included in or attached to a link measurement data unit or as a separate link measurement report.

18. First communication method of a first communication device configured to operate as access point (AP) and to communicate with a second communication device that is configured to operate as station (STA), the first communication method comprising:
transmitting trial information to the second communication device and at least two third communication devices, the trial information requesting the second communication device and at least two third communication devices to perform link measurement and transmit link measurement information,
performing link measurement and/or receive link measurement information from the second communication device and/or one or more third communication devices, and
scheduling, under consideration of the measured link and/or the received link measurement information, one or more overlay communication phases in which two third communication devices communicate with each other simultaneously with the communication between the first and second communication devices.

19. Third communication method of a third communication device configured to communicate with another third communication device, the third communication device comprising circuitry configured to:
receive trial information from a first communication device that is configured to operate as access point (AP) and to communicate with a second communication device that is configured to operate as station (STA), the trial information requesting the second communication device, the third communication device and at least another third communication device to perform link measurement and transmit link measurement information, and
participate in one or more overlay communication phases scheduled by the first communication device under consideration of the measured link and/or link measurement information, wherein the third communication device and another third communication device communicate with each other simultaneously with the communication between the first and second communication devices.

20. A non-transitory computer-readable recording medium that stores therein a computer program product, which, when executed by a processor, causes the method according to claim 18 or 19 to be performed.
